(19) United States
(12) Patent Application Publication
(10) Pub. No.: US 2004/0020594 A1
(43) Pub. Date: Feb. 5, 2004

(54) Hot laminating apparatus

(76) Inventor: Shih-Huang Lee, Taipei (TW)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/462,497

(22) Filed: Jun. 16, 2003

(30) Foreign Application Priority Data
Aug. 5, 2002 (TW) 091117602

(51) Int. Cl. B32B 31/00

(52) U.S. Cl. 156/272.2; 156/582

(57) ABSTRACT

A laminating apparatus for laminating a first layer to a second layer is provided. The laminating apparatus includes a preheating unit and a heating and pressing unit. The preheating unit receives a combination of the first layer and the second layer in contact with each other, and preheats the combination of the first layer and the second layer. The heating and pressing unit is disposed downstream of the preheating unit, and presses and simultaneously heats the combination of the first layer and the second layer so as to laminate the first layer to the second layer.

### FIELD OF THE INVENTION

The present invention relates to a laminating apparatus, and more particularly to a hot laminating apparatus for laminating a sheet between two pieces of plastic films.

### BACKGROUND OF THE INVENTION

Laminating apparatuses are widely used for laminating a sheet between two pieces of plastic films. A conventional laminating apparatus shown in FIG. 1(a) principally comprises two pairs of rollers, i.e. front rollers 10 and rear rollers 11, and a heating unit 12. The front rollers 10 comprise an upper front roller 101 and a lower front roller 102, while the rear rollers 11 comprise an upper rear roller 111 and a lower rear roller 112. The heating unit 12 comprises an upper heating element 121 and a lower heating element 122. The heating unit produces heat from electricity. The process for laminating a sheet material by way of the laminating apparatus is illustrated as follows. The sheet material is sandwiched between a pair of plastic films. The sandwiched structure is then fed to the passage between the upper heating element 121 and the lower heating element 122 by means of the front rollers 10, and the plastic films are heated and thus softened. Then, the sandwiched structure advances and is pressed to laminate by means the rear rollers 11 so as to bond the sheet material with the plastic films.

In the above-mentioned laminating apparatus, since the heating mechanism and pressing mechanism are separately performed by two individual units, the materials of the sheet and the plastic films should be limited to some special combinations in view of the heating and laminating timings. In addition, the laminating effect of such laminating apparatus is sometimes not satisfied, for example, due to formation of some bubbles in the resulting article.

In order to overcome the drawbacks, another laminating apparatus as shown in FIG. 1(b) was developed. Such laminating apparatus, also referred as “hot shoe”, comprises only a pair of rollers 22. The heat generated by heating plates 21 is uniformly distributed over aluminum extrusion elements 20, and radiated to heat up the rollers 22. Therefore, when the sheet material sandwiched between a pair of plastic films is fed through the rollers 22, the heating and pressing mechanisms are simultaneously performed thereon so as to avoid the problem of forming bubbles. Since heat for pressing the sandwiched structure is transferred to the rollers 22 through air gaps between the aluminum extrusion elements 20 and the rollers 22, a relatively long waiting time, for example 10-15 minutes, is required to warm up the laminating apparatus. Please refer to FIG. 1(c), curves A and B indicate temperature variations of the rollers 22 and the heating plates 21 with time, respectively. As shown, although the heating plates 21 rises to its target temperature (for example 100° C.) at a high rate, the rollers 22 needs a longer time (for example about 11 min.) to reach its working temperature (for example 95° C.). Therefore, due to insufficient heat transfer, it would be troublesome to laminate as many sheets as required continuously.

### SUMMARY OF THE INVENTION

It is an object of the present invention to provide a laminating apparatus capable of being rapidly warmed up and avoiding formation of bubbles.

In accordance with an aspect of the present invention, there is provided a laminating apparatus for laminating a first layer to a second layer. The laminating apparatus comprises a preheating unit and a heating and pressing unit. The preheating unit receives a combination of the first layer and the second layer in contact with each other, and preheats the combination of the first layer and the second layer. The heating and pressing unit is disposed downstream of the preheating unit, and presses and simultaneously heats the combination of the first layer and the second layer so as to laminate the first layer to the second layer.

In an embodiment, the laminating apparatus further comprises a feeding unit disposed upstream of the preheating unit, and comprising a first and a second feeding rollers formed therebetween a passage, from which the combination of the first layer and the second layer is fed to the preheating unit.

In an embodiment, the preheating unit comprises two heating plates, between which the combination of the first layer and the second layer passes to be preheated.

In an embodiment, the heating and pressing unit comprises a first heat radiator, a second heat radiator, a first pressing roller and a second pressing roller. The first and the second pressing rollers are partially enclosed by the first and the second heat radiators, respectively, wherein there are air gaps between the first heat radiator and the first pressing roller and between the second heat radiator and the second pressing roller.

In an embodiment, each of the first and the second heat radiators includes a heater for converting electricity to heat and an aluminum extrusion element for diffusing the heat.

In an embodiment, the first layer is a sheet material, and the second layer is a plastic film. In another embodiment, the first layer is a sheet material, the second layer comprises two plastic films, and the combination of the first and the second layer is a combination of plastic film, sheet material and plastic film in sequence.

In accordance with another aspect of the present invention, there is provided a laminating apparatus for laminating a first layer to a second layer. The laminating apparatus comprises a feeding unit, a preheating unit and a heating and pressing unit. The feeding unit is used for feeding a combination of the first layer and the second layer in contact with each other. The preheating unit is disposed downstream of the feeding unit for preheating the combination of the first layer and the second layer. The heating and pressing unit is disposed downstream of the preheating unit, and presses and simultaneously heats the combination of the first layer and the second layer so as to laminate the first layer to the second layer.

In accordance with another aspect of the present invention, there is provided a laminating apparatus for laminating a sheet material sandwiched between a pair of plastic films. The laminating apparatus comprises a feeding unit, a preheating unit and a heating and pressing unit. The feeding unit is used for feeding a combination of the sheet material sandwiched between the pair of plastic films. The preheating unit is disposed downstream of the feeding unit for preheating the combination of the sheet material sandwiched between the pair of plastic films. The heating and pressing unit is disposed downstream of the preheating unit, and presses and simultaneously heats the combination of the sheet material sandwiched between the pair of plastic films so as to laminate the sheet material sandwiched between the pair of plastic films.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1(a) is a cross-sectional view showing a conventional laminating apparatus;

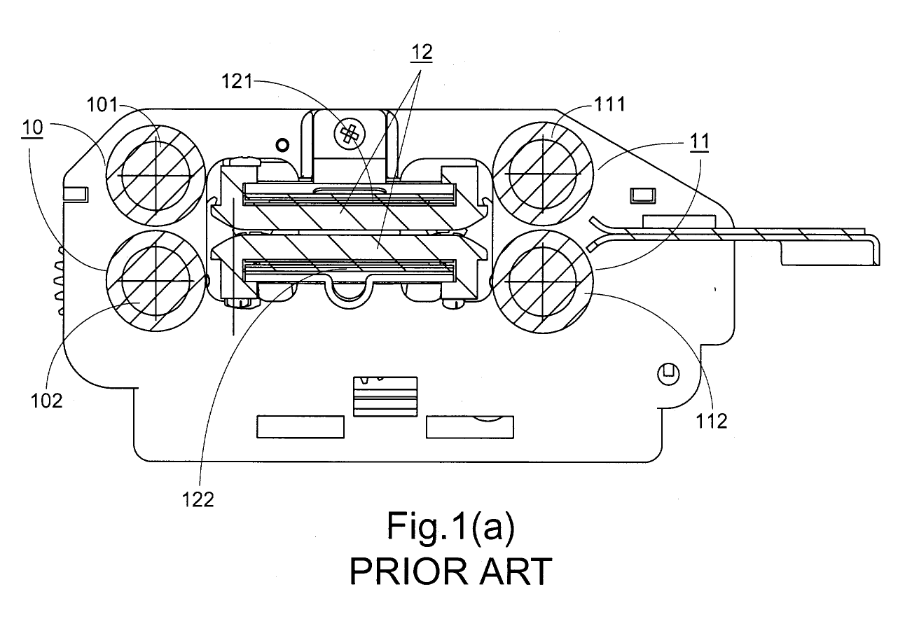

FIG. 1(b) is a cross-sectional view showing another conventional laminating apparatus;

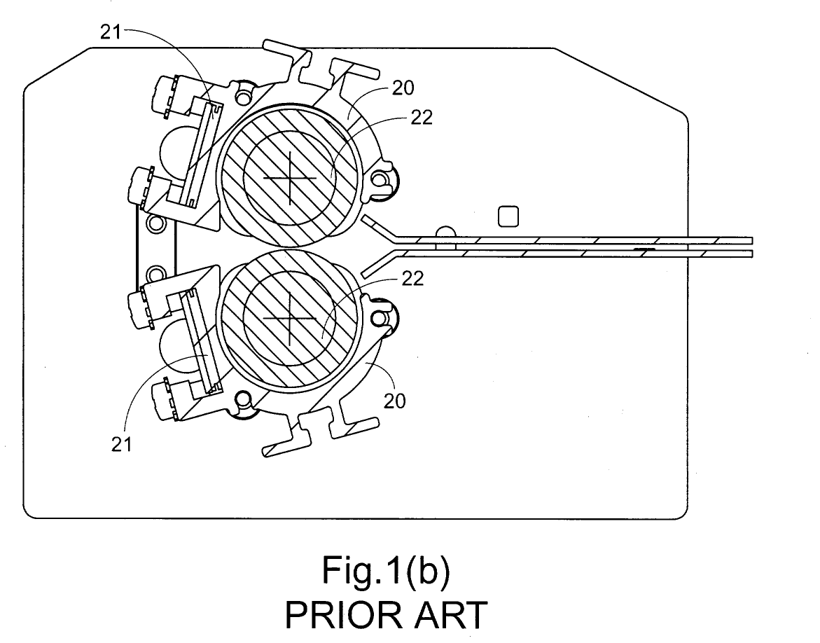

FIG. 1(c) illustrates temperature variation of the laminating apparatus in FIG. 1(b) during operation;

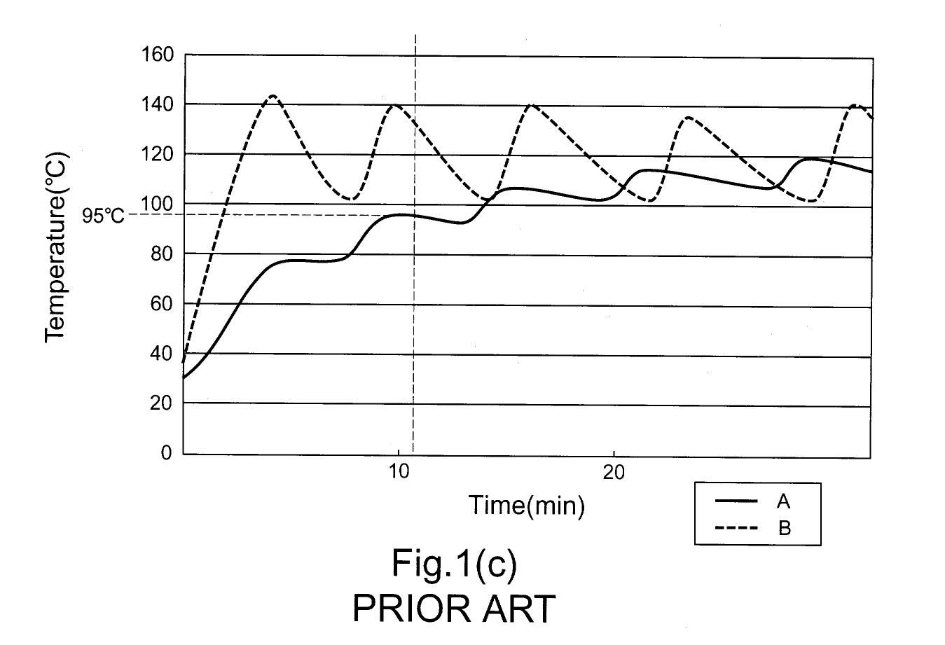

FIG. 2 is a cross-sectional view showing a laminating apparatus according to a preferred embodiment of the present invention; and

FIG. 3 illustrates temperature variation of the laminating apparatus in FIG. 2 during operation.

### DETAILED DESCRIPTION OF THE PREFERRED EMBODIMENT

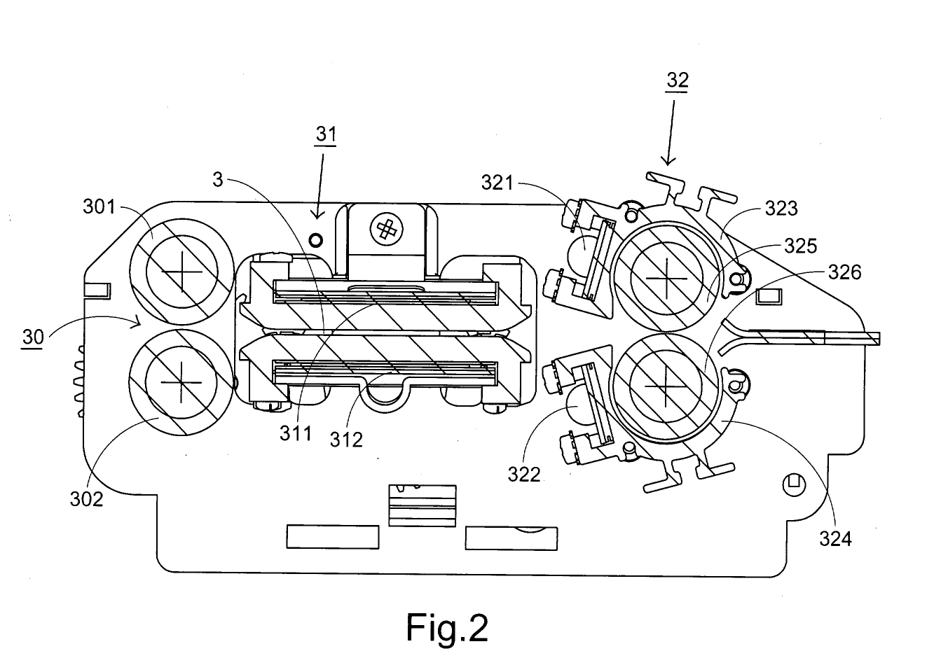

FIG. 2 is a cross-sectional view showing a laminating apparatus according to a preferred embodiment of the present invention. The laminating apparatus comprises a feeding unit 30, a preheating unit 31 and a heating and pressing unit 32. The feeding unit 30 comprises an upper feeding roller 301 and a lower feeding roller 302 cooperating to feed the article to be laminated into the laminating apparatus. The heating unit 31 comprises an upper heating element 311 and a lower heating element 312 transforming electricity to heat so as to preheat the article. The heating and pressing unit 32 comprises an upper heater 321, a lower heater 322, an upper aluminum extrusion element 323, a lower aluminum extrusion element 324, an upper heat roller 325 and a lower heat roller 326. The heat generated by the heater 321 is uniformly distributed over the aluminum extrusion element 323, and radiated to heat up the roller 325. Likewise, the heat generated by the heater 322 is uniformly distributed over the aluminum extrusion element 324, and radiated to heat up the roller 326.

The process for laminating a sheet material by using the laminating apparatus of FIG. 2 is illustrated as follows. Firstly, the sheet material is sandwiched between a pair of plastic films (not shown). Then, the sandwiched structure is fed to the passage 3 between the upper heating element 311 and the lower heating element 312 by means of the counter-rotation of the feeding rollers 301 and 302. During this stage, the sandwiched structure is preheated to a certain extent. Then, the sandwiched structure advances through the heating and pressing unit 32 to be further heated. The heat rollers 325 and 326 press against opposite sides of the sandwiched structure, and transmit the heat received from the heaters 321, 322 and the heat radiators 324, 325 to the sandwiched structure so as to soften the plastic films. Being pressed by the heat rollers 325 and 326, the sheet material bonds with the softened plastic films to form a laminate structure as desired. Due to the simultaneous heating and pressing mechanisms performed on the heating and pressing unit 32, the problem of forming bubbles is significantly eliminated.

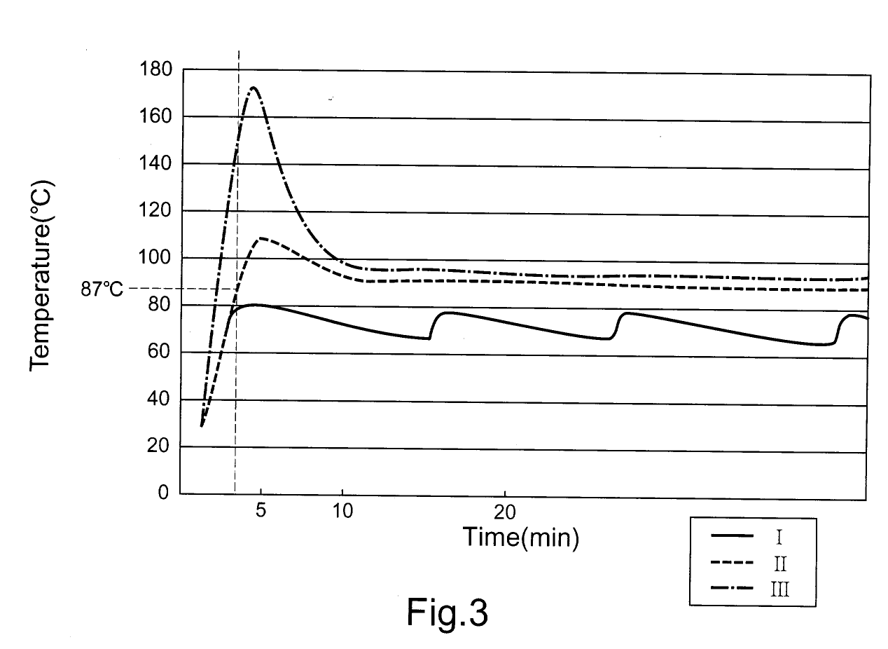

Please refer to FIG. 3, curves I, II and III indicate temperature variations of the heating element 311 or 312, the heat roller 325 or 326 and the heater 321 or 322 with time, respectively. Since the sandwiched structure is preheated by the heating unit 31, less heat is required from the heating and pressing unit 32 in order to soften the plastic films and laminate the sandwiched structure. In other words, the working temperature of the heat roller 325 or 326 is lowered to about 87° C. Therefore, shorter time (for example around 3.5 min) is spent to provide the relatively small amount of heat or reach the relatively low working temperature.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A laminating apparatus for laminating a first layer to a second layer, comprising:
a preheating unit receiving a combination of said first layer and said second layer in contact with each other, and preheating said combination of said first layer and said second layer; and
a heating and pressing unit disposed downstream of said preheating unit, and pressing and simultaneously heating said combination of said first layer and said second layer so as to laminate said first layer to said second layer.

2. The laminating apparatus according to claim 1 further comprises a feeding unit disposed upstream of said preheating unit, and comprising a first and a second feeding rollers formed therebetween a passage, from which said combination of said first layer and said second layer is fed to said preheating unit.

3. The laminating apparatus according to claim 1 wherein said preheating unit comprises two heating plates, between which said combination of said first layer and said second layer passes to be preheated.

4. The laminating apparatus according to claim 1 wherein said heating and pressing unit comprises:
a first and a second heat radiators; and
a first and a second pressing rollers partially enclosed by said first and said second heat radiators, respectively, there being air gaps between said first heat radiator and said first pressing roller and between said second heat radiator and said second pressing roller.

5. The laminating apparatus according to claim 4 wherein each of said first and said second heat radiators includes a heater for converting electricity to heat and an aluminum extrusion element for diffusing the heat.

6. The laminating apparatus according to claim 1 wherein said first layer is a sheet material, and said second layer is a plastic film.

7. The laminating apparatus according to claim 1 wherein said first layer is a sheet material, said second layer comprises two plastic films, and said combination of said first and said second layer is a combination of plastic film, sheet material and plastic film in sequence.

8. A laminating apparatus for laminating a first layer to a second layer comprising:
a feeding unit for feeding a combination of said first layer and said second layer in contact with each other;
a preheating unit disposed downstream of said feeding unit for preheating said combination of said first layer and said second layer; and
a heating and pressing unit disposed downstream of said preheating unit, and pressing and simultaneously heating said combination of said first layer and said second layer so as to laminate said first layer to said second layer.

9. The laminating apparatus according to claim 8 wherein said feeding unit comprises a first and a second feeding rollers formed therebetween a passage, from which said combination of said first layer and said second layer is fed to said preheating units.

10. The laminating apparatus according to claim 8 wherein said preheating unit comprises two heating plates, between which said combination of said first layer and said second layer passes to be preheated.

11. The laminating apparatus according to claim 8 wherein said heating and pressing unit comprises:
a first and a second heat radiators; and
a first and a second pressing rollers partially enclosed by said first and said second heat radiators, respectively, there being air gaps between said first heat radiator and said first pressing roller and between said second heat radiator and said second pressing roller.

12. The laminating apparatus according to claim 11 wherein each of said first and said second heat radiators includes a heater for converting electricity to heat and an aluminum extrusion element for diffusing the heat.

13. The laminating apparatus according to claim 8 wherein said first layer is a sheet material, and said second layer is a plastic film.

14. The laminating apparatus according to claim 8 wherein said first layer is a sheet material, said second layer comprises two plastic films, and said combination of said first and said second layer is a combination of plastic film, sheet material and plastic film in sequence.

15. A laminating apparatus for laminating a sheet material sandwiched between a pair of plastic films, said laminating apparatus comprising:
a feeding unit for feeding a combination of said sheet material sandwiched between said pair of plastic films;
a preheating unit disposed downstream of said feeding unit for preheating said combination of said sheet material sandwiched between said pair of plastic films; and
a heating and pressing unit disposed downstream of said preheating unit, and pressing and simultaneously heating said combination of said sheet material sandwiched between said pair of plastic films so as to laminate said sheet material sandwiched between said pair of plastic films.

16. The laminating apparatus according to claim 15 wherein said feeding unit comprises a first and a second feeding rollers formed therebetween a passage, from which said combination of said sheet material sandwiched between said pair of plastic films is fed to said preheating units.

17. The laminating apparatus according to claim 15 wherein said preheating unit comprises two heating plates, between which said combination of said sheet material sandwiched between said pair of plastic films passes to be preheated.

18. The laminating apparatus according to claim 15 wherein said heating and pressing unit comprises:
a first and a second heat radiators; and
a first and a second pressing rollers partially enclosed by said first and said second heat radiators, respectively, there being air gaps between said first heat radiator and said first pressing roller and between said second heat radiator and said second pressing roller.

19. The laminating apparatus according to claim 18 wherein each of said first and said second heat radiators includes a heater for converting electricity to heat and an aluminum extrusion element for diffusing the heat.
